(19) United States
(12) Patent Application Publication
(10) Pub. No.: US 2019/0324912 A1
(43) Pub. Date: Oct. 24, 2019

(54) CACHE MEMORY SHARED BY SOFTWARE HAVING DIFFERENT TIME-SENSITIVITY CONSTRAINTS

(71) Applicant: MediaTek Singapore Pte. Ltd., Singapore (SG)

(72) Inventor: Jukka Toivanen, Oulu (FI)

(21) Appl. No.: 15/956,010

(22) Filed: Apr. 18, 2018

(51) Int. Cl. G06F 12/0846; G06F 12/084; G06F 12/0873; G06F 12/0871; G06F 12/0842; G06F 12/06

(52) U.S. Cl. CPC G06F 12/0848; G06F 12/084; G06F 12/0873; G06F 2212/608; G06F 12/0842; G06F 12/0646; G06F 2212/282; G06F 12/0871

(57) ABSTRACT

A device including a cache memory that is partitioned into at least a first partition and a second partition. The first partition and the second partition are distinguishable by memory addresses. The first partition is dedicated to a first category of software and the second partition is dedicated to a second category of software. The first category and the second category have different time-sensitivity constraints. The device further includes a processor operative to execute software that includes a first software portion belonging to the first category and a second software portion belonging to the second category.

### TECHNICAL FIELD

Embodiments of the invention relate to cache memory management.

### BACKGROUND

In embedded computing systems, cache memories are increasingly used to optimize silicon area. Usage of cache memory sometimes causes unpredictable software timing behavior as the amount of cache misses during software execution highly affects the software execution speed.

Embedded software typically consists of time-sensitive software content and non-time-sensitive software content. Time-sensitive software execution must be completed before certain time deadline, or system fails to operate correctly. Non-time-sensitive software has no strict time deadlines. Classification of the time-sensitive and non-time-sensitive software parts is usually known in advance of runtime, e.g., at software compilation time.

Time-sensitive software and non-time-sensitive software concurrently executed in the same processing system can share the same cache memory. Non-time-sensitive software execution can cause time-sensitive software content being removed from cache memory. When time-sensitive software execution starts again, the performance of the execution may be poor if the cache memory content of the time-sensitive software has been replaced by the non-time-sensitive software.

Conventional approaches, in general, address this time-sensitive and non-time-sensitive software execution problem by adding more hardware to the system. The added hardware can be memory, processors, or a combination of both. Adding hardware increases the cost of the system. The following describes some of the convention approaches.

For example, a separate non-cached fast memory module can be added to a processor for storing the time-sensitive software only. As the fast memory is non-cached, the non-time-sensitive software cache usage will not affect accesses to this fast memory. Adding the non-cached fast memory to the processor is very expensive, as the non-cached fast memory needs to be sufficient large to contain all the time-sensitive software. Moreover, the fast memory content does not automatically adapt if the active context of the time-sensitive software changes.

Another approach is to execute non-time-sensitive software only from non-cached memory; i.e., use cache only for the time-sensitive software. This approach reduces the performance of the non-time-sensitive software, as typically non-cached memory speed is much lower than the processor speed. The performance degradation can be so significant that this is not a feasible solution in practice.

Alternatively, a bigger common cache can be added to hardware. A bigger cache means it is less likely that the non-time-sensitive software removes time-sensitive software content from the cache. Adding a bigger cache increases the size and cost of the hardware, and makes the timing closure of the hardware more difficult.

A yet another approach is to add to the system a separate processor, including its own memories, for executing the time-sensitive software. This processor runs only the time-sensitive software, and is not affected by the non-time-sensitive software execution in a separate processor. Adding more processors to system increases hardware cost, and also introduces more processor-to-processor interfaces to hardware and software, complicating the system design.

### SUMMARY

In one embodiment, a device is provided for executing software of two or more categories. The device comprises a processor operative to execute the software, the software including a first software portion belonging to a first category and a second software portion belonging to a second category. The first category and the second category have different time-sensitivity constraints. The device further comprises a cache memory coupled to the processor. The cache memory includes at least a first partition and a second partition. The first partition is dedicated to the first category and the second partition is dedicated to the second category. The device further comprises circuitry operative to receive a memory access request specifying a memory address, and determine whether to access the first partition or the second partition by the memory address.

In another embodiment, a method is provided for operating a cache memory. The method comprises: receiving a memory access request specifying a memory address; and determining whether to access a first partition or a second partition of the cache memory by the memory address. The first partition is dedicated to a first category of software and the second partition is dedicated to a second category of software. The first category and the second category have different time-sensitivity constraints.

By dividing the cache memory into different partitions for software having different time-sensitivity constraints, the predictability of time-sensitive software memory access and execution is improved. The execution of non-time-sensitive software does not affect the cache behavior of the time-sensitive software as the different software categories use different partitions of the cache memory.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates an example of a software execution sequence.

FIG. 2 illustrates an example of a device in which embodiments of the invention may operate.

FIG. 3 illustrates cache memory partitions according to one embodiment.

FIG. 4 illustrates a mapping between cache memory partitions and physical memory address space according to one embodiment.

FIG. 5 illustrates the memory address space addressable by a processor and the physical memory address space according to one embodiment.

FIG. 6 is a software execution sequence illustrating an example of runtime mode change according to one embodiment.

FIG. 7 is a flow diagram illustrating a method for operating a cache memory according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a mechanism for time-sensitive software and non-time-sensitive software to share a cache memory in a processing system. Software to be executed by a processing system is classified into two or more categories, each having a different time-sensitivity requirement. The processing system uses different partitions of the cache memory for different categories of software. The processing system includes hardware which differentiates different categories of memory accesses; e.g., between memory access to a time-sensitive software portion and memory access to a non-time-sensitive software portion. For example, the hardware may monitor a bit in the memory address that has been reserved for the purpose of differentiating different categories of memory accesses. Alternatively, information for differentiating different categories of memory accesses may be provided by a memory management unit (MMU) or other means. A “portion” or “content” of software may include instructions, functions and/or data.

In some embodiments, the processing system includes programmable hardware which at runtime can dynamically change the sizes and boundaries of the cache memory partitions. The partitioning of the cache memory enables predictable and deterministic behaviors of the time-sensitive software without increasing processor count and memory size.

Due to the partitioning of the cache memory, the non-time-sensitive software execution does not affect the cache behavior of time-sensitive software. As the partitioning is runtime configurable, flexibility can be further enhanced by using different partitioning schemes in different use cases.

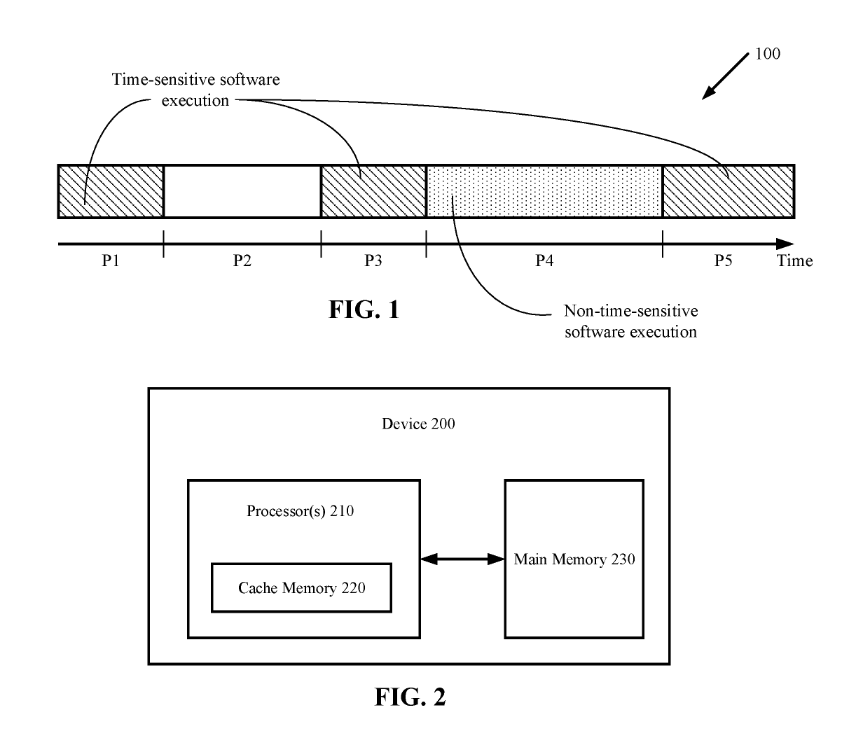

FIG. 1 illustrates an example of a software execution sequence 100. The software execution sequence 100 is shown as a function of time, where time advances from left to right. In this example, time-sensitive software is executed at high priority in execution periods P1, P3 and P5. During time period P2, which is between the time-sensitive software execution periods P1 and P3, there is no non-time-sensitive software to execute and the processor is in an idle mode. Non-time-sensitive software is executed during execution period P4, which is between the time-sensitive software execution periods P3 and P5.

As mentioned before, both time-sensitive software and non-time-sensitive software share the same cache memory. In a conventional system where there are no cache partitions, the non-time-sensitive execution in period P4 could replace time-sensitive content of the cache with non-time-sensitive content, and the cache would contain mostly non-time-sensitive software content when execution period P5 starts. Thus, time-sensitive software execution in P5 would take much longer than periods P1 and P3 as the processor would have to fetch the time-sensitive software content from the main memory.

The time-sensitive software behavior can be made more deterministic by classifying the software functions and data to time-sensitive and non-time-sensitive categories, and using different cache memory partitions for time-sensitive and non-time-sensitive software. The cache partitioning scheme improves the system performance not only for sequential execution of time-sensitive and non-time-sensitive software as shown in FIG. 1, but also for concurrent execution of time-sensitive and non-time-sensitive software.

FIG. 2 illustrates an example of a device 200 in which embodiments of the invention may operate. The device 200 includes at least a processor 210, which may be a general-purpose processor or a special-purpose processor; e.g., a central processing unit (CPU), a graphics processing unit (GPU), a digital signal processor (DSP), a network processor, a microcontroller, etc. The device 200 may be a desktop, a laptop, a server, a tablet, an Internet-connected device, a smart phone, a wearable device, a multimedia device, a gaming device, a navigation device, an embedded device, to mention some examples.

The device 200 also includes a cache memory 220 and a main memory 230. In one embodiment, the cache 220 may include a static random access memory (SRAM) device and/or other volatile or non-volatile memory devices. The memory 230 may include a dynamic random access memory (DRAM) device, a flash memory device and/or other volatile or non-volatile memory devices. Although the cache memory 220 in FIG. 2 is shown to be within the processor 210 (e.g., on the processor die or processor package), in some embodiments the cache memory 220 may be outside the processor 210. Alternatively, the cache memory 220 may be partially within the processor 210 and partially outside the processor 210; e.g., the cache memory 220 may include one or more low-level cache units within the processor 210 and one or more high-level cache units outside the processor 210.

The cache memory 220 stores copies of main memory content that is or predicted to be frequently used. The size of the cache memory 220 is typically smaller compared to the size of the main memory 230, but it is much faster to access the cache memory 220 than the main memory 230. By storing the frequently used data in the cache memory 220, the processor 210 can execute faster as the cache memory 220 access time is much shorter compared to the main memory 230 access time.

The processor 210 may execute a number of different types (i.e., categories) of software. In one embodiment, the processor 210 may execute software having time constraints, such as embedded software which includes time-sensitive portions and non-time-sensitive portions. For example, in telecommunication systems, protocol software can be divided to time-sensitive software portion (e.g., part of “physical layer” or “Layer 1” of protocol software) and non-time-sensitive software portion (e.g., part of “Layer 2” and “Layer 3” of protocol software). Another example is “Internet-of-things” (IoT) software which may be divided to time-sensitive software portion (e.g., part of physical layer protocol software) and non-time-sensitive software portion (e.g., application layer software). The time-sensitive portions and the non-time-sensitive portions of the software may share the same cache memory 220.

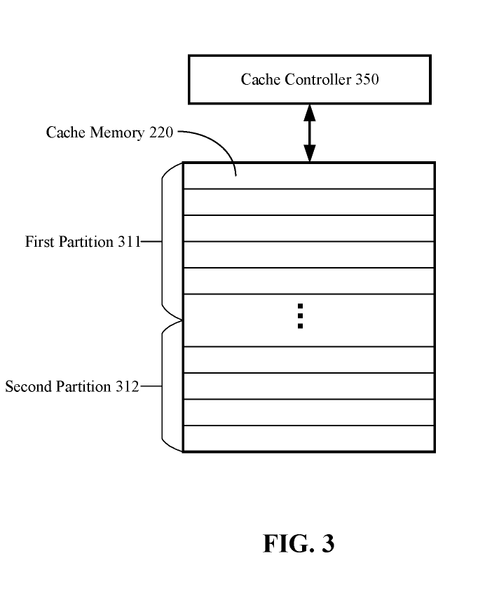

FIG. 3 illustrates cache memory partitions according to one embodiment. The cache memory 220 may be partitioned into at least two partitions: a first partition 311 reserved for time-sensitive software content and a second partition 312 reserved for non-time-sensitive software content. In an alternative embodiment where software is classified into more than two levels of time sensitivity, the cache memory 220 may include a corresponding number of partitions, with each partition dedicated to one level of time sensitivity. Although FIG. 3 shows the first partition 311 and the second partition 312 as two contiguous regions, in some embodiments, the first partition 311 and/or the second partition 312 may include cache lines that are non-contiguous. In one embodiment, the cache lines belonging to the first partition 311 may interleave with the cache lines belonging to the second partition 312.

Referring to FIG. 3, time-sensitive software content can be stored only in the first partition 311 and non-time-sensitive software content can be stored only in the second partition 312. The partitions separate time-sensitive and not-time-sensitive memory accesses such that different cache partitions are used for different types (i.e., access types) of memory accesses. Memory accesses of different types are allowed to perform cache read and write within their own partitions, and are not allowed to replace the cache lines across partition boundaries. More specifically, the cache controller 350 or similar hardware circuitry performs cache line replacement within each partition and does not allow cache line replacement across partition boundaries; that is, a time-sensitive cache line can only replace another time-sensitive cache line, but not a non-time-sensitive cache line; a non-time-sensitive cache line can only replace another non-time-sensitive cache line, but not a time-sensitive cache line.

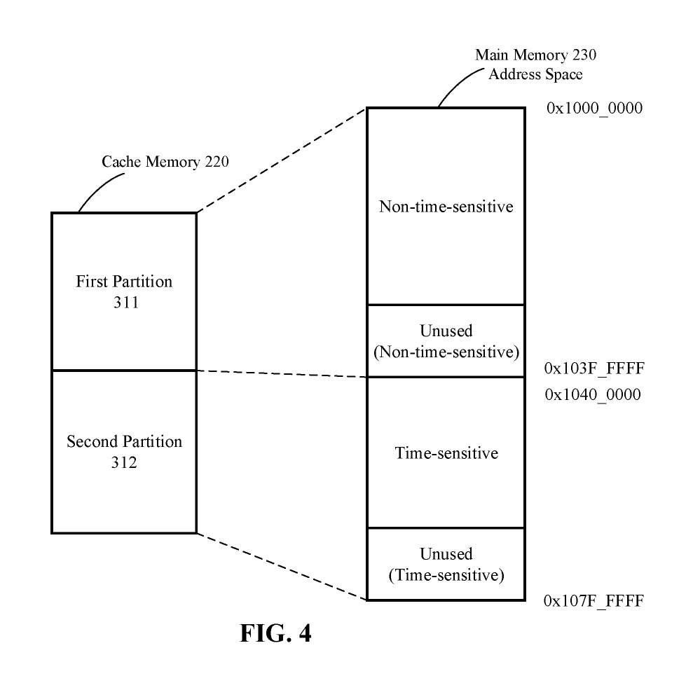

FIG. 4 illustrates a mapping between partitions of the cache memory 220 and the physical memory address space of the main memory 230 according to one embodiment. In one embodiment, cache memory 220 may be partitioned according to the memory addresses. In one embodiment, the programmer may instruct, or provide a hint, in a software program to indicate the time sensitivity of different portions of the software program. At the compilation phase, a compiler may assign different linker code sections to the time-sensitive portions and the non-time-sensitive portions of the software. At the linking phase, the different linker code sections link the time-sensitive software to a first memory address area and the non-time-sensitive software to a second memory address area different from the first memory address area. Then the memory address of a memory access can be used by a cache controller 350 to detect the type (e.g. time-sensitive or non-time-sensitive) of the memory access. In an alternative embodiment where the device 200 contains a MMU or similar hardware circuitry, the MMU (or similar hardware circuitry) may be used to detect the type of a memory access.

In one embodiment, time-sensitive software may be assigned to memory address areas in a first address range, and non-time-sensitive software may be assigned to memory address areas in a second address range. In one embodiment, the first address range and the second address range may be distinguished by memory address comparison, such as comparing the values of one or more address bits.

In one embodiment, the first address range and the second address range may be distinguished by a single address bit. FIG. 4 illustrates an example where time-sensitive and non-time-sensitive software have been linked such that bit 22 in the memory address is used to distinguish the two software categories. In this example, bit 22 is “0” for non-time-sensitive software and “1” for time-sensitive software. For example, the address range 0x000_0000-0x103F_FFFF is assigned to non-time-sensitive software, and the address range 0x1040_0000-0x107F_FFFF is assigned to time-sensitive software. In FIG. 4, each address range has an unused address area near the end of the range. In alternative embodiments, the unused address areas may be at any location of the respective address ranges and may be broken up into more than one area. It is understood that another memory address bit, a different number of bits and/or different bit values may be used in the memory address for distinguishing different types of memory accesses.

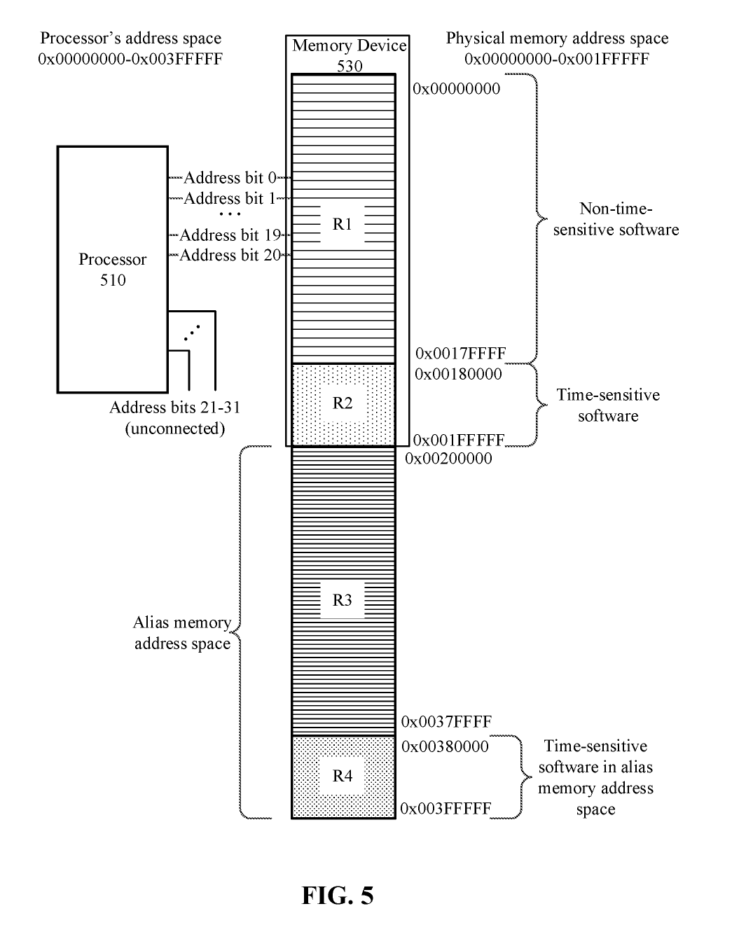

The aforementioned memory address in connection with FIG. 4 is a physical memory address that lies in the physical memory address space of the main memory (e.g., the main memory 230 of FIG. 2). In some embodiments, the memory address that is used to differentiate different types of memory accesses may be an address that lies in the processor's address space. A processor's address space may be larger than the physical memory address space, as shown in the example of FIG. 5.

FIG. 5 illustrates a processor's memory address space and the physical memory address space according to one embodiment. The processor 510 and the memory device 530 may be an example of the processor 210 and the main memory 230 of FIG. 2, respectively. In this example, the processor 510 has 32 address bits (0-31), and the size of the memory device 530 is 2 megabytes which is addressed by 21 memory address bits corresponding to 21 memory address lines. The processor's address bits 0-20 are connected to the memory address lines 0-20. Thus, the physical memory address space is visible to (i.e., addressable by) the processor 510 in address area 0x0000_0000-0x001F_FFFF, indicated as R1 and R2, where R1's address range is 0x0000_0000-0x0017_FFFF and R2's address range is 0x0018_0000-0x001F_FFFF. Address area 0x0020_0000-0x003F_FFFF, indicated as R3 and R4, is also visible to the processor 510. R3's address range is 0x0020_0000-0x0037_FFFF and R4's address range is 0x0038_0000-0x003F_FFFF. Notice that the only difference between addresses 0x0000_0000 and 0x0020_0000 (the beginning addresses of R1 and R3, respectively) is bit 21. In this example, every memory address in R1 (with bit 21=0) has a corresponding memory address in R3 (with bit 21=1), where the only difference in their respective addresses is bit 21. Similarly, every memory address in R2 (with bit 21=0) has a corresponding memory address in R4 (with bit 21=1), where the only difference in their respective addresses is bit 21.

When the processor 510 accesses memory addresses in range 0x0000_0000-0x001F_FFFF (i.e., R1 and R2), it sees (that is, accesses) the physical memory address space provided by the memory device 530. When the processor 510 accesses memory addresses in range 0x0020_0000-0x003F_FFFF (i.e., R3 and R4), it also sees the same physical memory address space provided by the memory device 530. This effect is called address aliasing. Address areas (R1, R2) and (R3, R4) have the same address bits 0-20, and the difference is in address bit 21. However, bit 21 (or any of the most significant bits above bit 21) is not used by the processor 510 to access the actual physical memory, only bits 0-20 are connected and used. Because of this aliasing effect, the same physical memory address space of the memory device 530 can be seen by the processor 510 in multiple areas of the processor's address space. As shown in FIG. 5, the memory address area (R3 and R4), which is in the processor's address space but outside the physical memory address space, is referred to as an alias memory address space. To the processor 510, the alias memory address space stores the same data as the physical memory (R1 and R2).

In one embodiment, the aliasing effect may be utilized so that at the software linking stage, the non-time-sensitive software is linked to a block at the beginning of the physical memory (e.g. R1), and the time-sensitive software is linked to a block in the alias memory address space after the non-time-sensitive software (e.g. R4). The borders of these two blocks may be configurable to any address boundary, as long as the difference from the end of the non-time-sensitive block to the start of time-sensitive block is the size of the memory device 530. During execution of the software, the non-time-sensitive software may be cached in a first partition of the cache memory and the time-sensitive software may be cached in a second partition of the cache memory.

It is noted that in the example of FIG. 5, the time-sensitive software is stored in the physical memory area R2, i.e., the physical memory addresses 0x00180000-0x001F_FFFF. However, when the processor 510 accesses non-time-sensitive software, it uses addresses 0x0000_0000-0x001F_FFFF, and for time-sensitive software it uses addresses 0x0020_0000-0x003F_FFFF, which belong to the alias memory address space and do not exists in the memory device 530. Because of aliasing, the processor 510 actually fetches the data from addresses 0x0000_0000-0x001F_FFFF for both types of memory accesses. To the processor 510, address bit 21 is different in non-time-sensitive addresses and time sensitive addresses even though both addresses go to the same address range in the physical memory address space. Thus, in an embodiment where a processor has unused address bits for memory access, any one of these unused bits can be used for distinguishing time-sensitive memory access from non-time-sensitive memory access. More than one unused bit may be used for distinguishing more than two types of memory accesses.

In one embodiment, software categories and their corresponding memory accesses may be distinguished by memory addresses using more than one address bit. For example, a system may have physical memory starting from address S and ending at address E. Non-time-sensitive content is located at an address area starting from S, and time-sensitive content starting from T, where S<T<E. The cache device includes a register where the address range boundary value T can be written to. Thus, the address range boundary is programmable. The cache device also includes a comparator which compares a memory address with the boundary value, and outputs a bit for selecting a cache partition. For example, when a cache miss occurs and cache partition for new data needs to be decided, the cache device compares the miss address to the value of T. If the miss address is smaller than T then access category is non-time-sensitive, otherwise it is time-sensitive.

In one embodiment, the sizes of the partitions may be runtime configurable to allow adaptation for different use cases. For example, if the device 200 has cache memory of size 64 Kbytes, the hardware may contain a number of options for time-sensitive and non-time-sensitive memory partitions; e.g., 32 Kbytes/32 Kbytes; 40 Kbytes/24 Kbytes; 48 Kbytes/16 Kbytes; 56 Kbytes/8 Kbytes. The cache controller 350 (or the MMU or similar hardware circuitry) may also dynamically adjust the memory address ranges associated with the changed partition sizes.

In one embodiment, the cache memory 220 can be operated in a partitioned mode, where the cache memory is partitioned into two or more areas for access by software of different categories. The partitioned mode may be turned off. The partitioned mode may be turned on and off by hardware control or software control.

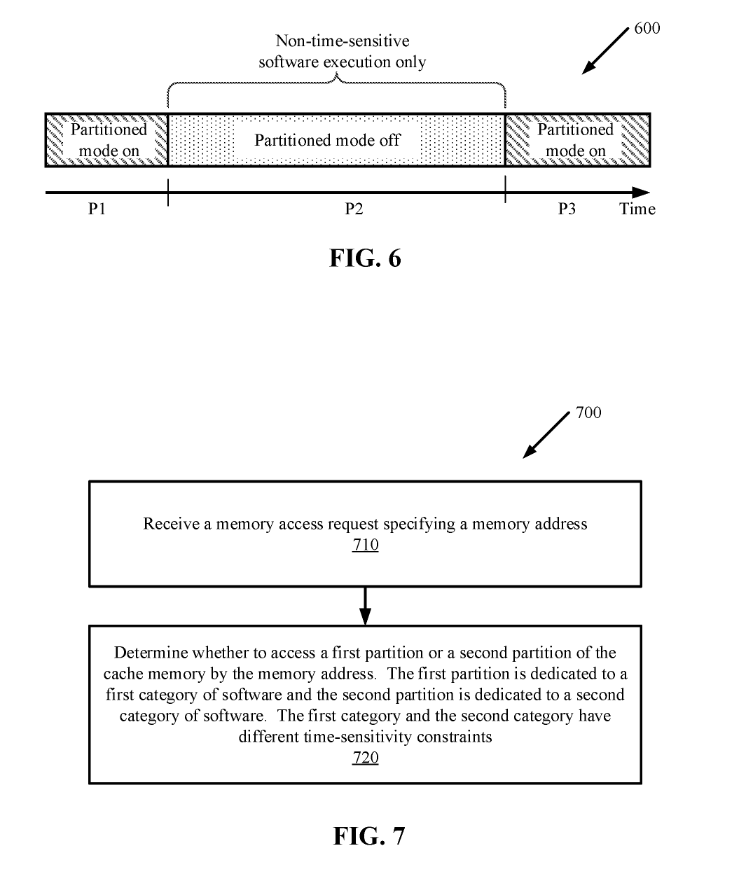

FIG. 6 is a software execution sequence 600 illustrating an example of runtime mode change according to one embodiment. In this example the time-sensitive software is stopped after execution period P1. At this point the cache memory mode is changed from the partitioned mode on to the partitioned mode off. When non-time-sensitive software runs during execution period P2, it can fully utilize the cache as the partitioned mode has been turned off. When the time-sensitive software is started again at the beginning of execution period P3, the partitioned mode is turned back on. By changing the partitioned mode at runtime, cache resources can be utilized optimally for each use case.

The cache partitioning techniques described above can be extended to three or more software types and cache partitions. In some embodiments, the software may be classified into three or more time-sensitivity categories, and the cache memory may have three or more partitions, one for each software category.

FIG. 7 is a flow diagram illustrating a method 700 for operating a cache memory according to one embodiment. In one embodiment, the method 700 may be performed by the device 200 of FIG. 2. However, it should be understood that the operations of the flow diagram of FIG. 7 can be performed by embodiments of the invention other than the embodiment of FIG. 2, and the embodiment of FIG. 2 can perform operations different than those discussed with reference to the flow diagram of FIG. 7.

The method 700 begins at step 710 with a device receiving a memory access request specifying a memory address. At step 720, the device determines whether to access a first partition or a second partition of the cache memory by the memory address. The first partition is dedicated to a first category of software and the second partition is dedicated to a second category of software. The first category and the second category have different time-sensitivity constraints. In one embodiment, the first category of software is non-time-sensitive software and the second category of software is time-sensitive software. In one embodiment, the first partition is mapped to a first memory address range and the second partition is mapped to a second memory address range. The first memory address range and the second memory address range may be distinguished by one address bit. The memory addresses may be in the physical memory address space; alternatively, the memory addresses may be in the processor's memory address space. In one embodiment, the cache memory may be partitioned into more than two partitions, with each partition dedicated to storing software of a different level of time sensitivity.

While the flow diagrams of FIG. 7 show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A device operative to execute software of two or more categories, comprising:
a processor operative to execute the software, the software including a first software portion belonging to a first category and a second software portion belonging to a second category, wherein the first category and the second category have different time-sensitivity constraints;
a cache memory coupled to the processor, the cache memory including at least a first partition and a second partition, the first partition dedicated to the first category and the second partition dedicated to the second category; and
circuitry operative to receive a memory access request specifying a memory address, and determine whether to access the first partition or the second partition by the memory address.

2. The device of claim 1, wherein the first partition is mapped to a first memory address range and the second partition is mapped to a second memory address range.

3. The device of claim 2, wherein the first memory address range and the second memory address range are in a physical memory address space of a memory device.

4. The device of claim 2, wherein the first memory address range is in a physical memory address space of a memory device, and the second memory address range is in an alias memory address space outside the physical memory address space.

5. The device of claim 4, wherein an address area between an ending boundary of the first memory address range and a beginning boundary of the second memory address range has a same size as the physical memory address space.

6. The device of claim 1, further comprising circuitry operative to detect an access type of a memory access according to one address bit of the memory access.

7. The device of claim 1, wherein the cache memory is configurable to operate in one of a partitioned mode and a non-partitioned mode.

8. The device of claim 1, wherein the cache memory is configurable to have different partition sizes.

9. The device of claim 1, wherein the cache memory is configurable to have more than two partitions dedicated to more than two categories of software.

10. The device of claim 1, wherein the cache memory partitioning is configurable at runtime according to the software being executed.

11. A method for operating a cache memory, comprising:
receiving a memory access request specifying a memory address; and
determining whether to access a first partition or a second partition of the cache memory by the memory address, wherein the first partition is dedicated to a first category of software and the second partition is dedicated to a second category of software, and wherein the first category and the second category have different time-sensitivity constraints.

12. The method of claim 11, wherein the first partition is mapped to a first memory address range and the second partition is mapped to a second memory address range.

13. The method of claim 12, wherein the first memory address range and the second memory address range are in a physical memory address space of a memory device.

14. The method of claim 12, wherein the first memory address range is in a physical memory address space of a memory device, and the second memory address range is in an alias memory address space outside the physical memory address space.

15. The method of claim 14, wherein an address area between an ending boundary of the first memory address range and a beginning boundary of the second memory address range has a same size as the physical memory address space.

16. The method of claim 11, further comprising: detecting an access type of a memory access according to one address bit of the memory access.

17. The method of claim 11, wherein the cache memory is configurable to operate in one of a partitioned mode and a non-partitioned mode.

18. The method of claim 11, wherein the cache memory is configurable to have different partition sizes.

19. The method of claim 11, wherein the cache memory is configurable to have more than two partitions dedicated to more than two categories of software.

20. The method of claim 11, wherein the cache memory partitioning is configurable at runtime according to the software being executed.
